(19) United States
(12) Patent Application Publication
(10) Pub. No.: US 2008/0228888 A1
(43) Pub. Date: Sep. 18, 2008

(54) Method for Redirection of Instant Messages

(76) Inventors: Liliana Orozco, Del Valle, TX (US); Christopher Hoang Doan, Austin, TX (US); Alejandro Duran, Cedar Park, TX (US); Kristin Lee Neiman, Round Rock, TX (US)

Correspondence Address: IBM CORPORATION;C/O DARCELL WALKER, ATTORNEY AT LAW, P. O. Box 25048, HOUSTON, TX, 77265, US

(21) Appl. No.: 12/127,848

(22) Filed: May 28, 2008

Related U.S. Application Data
(63) Continuation of application No. 11/044,367, filed on Jan. 27, 2005.

(51) Int. Cl. G06F 15/16

(52) U.S. Cl. 709/206

(57) ABSTRACT

The present invention a method by which the sender of an instant message can designate an alternate recipient of the message in the event the initial recipient does not respond to the message within a predetermined time period. The sender can create a list of one or more alternate recipients for a message. The sender can also specify a response time for the message. If the initial recipient does not response to the message within the defined time period, the message will be sent to a designated alternate recipient. In this invention, there can be multiple alternate recipients. Each alternate can receive the message or there can be a priority among the alternate recipients.

### FIELD OF THE INVENTION

The present invention relates to a method and system for increasing the efficiency of a response to a transmitted instant message and in particular to an instant messaging method and system that redirects a transmitted instant message to an alternate recipient when the primary recipient of the instant message does not respond to the message in a defined period of time.

### BACKGROUND OF THE INVENTION

Electronic mail (email) communications are an integral part of any business, and widely used outside of business as well. Although several new technologies currently compete, as the most ubiquitous tool in business communications, email remains one of the single most used communications tools for both the business and the personal user. Widespread availability, ease of use, and functionality are key components which hold email in front of developing communications methods; however, as new technologies compete for the top spot, email applications must continue to build upon the strong foundation currently in place to maintain their edge as the tool of choice. By any current standard, email applications would have to be rated as mature technology; however, if improvements in email applications cease to move forward, and other tools continue to improve, loss of market share will undoubtedly result.

E-mail is now a standard form of communication and information exchange. Telephone via the personal computer and shared collaboration are widely accepted and utilization of these modes are growing daily. Although E-mail is the main form of Internet communication, another new and popular form of Internet communication, instant messaging (“IM”), has emerged. Instant messaging is also becoming prevalent as a private extension to chat groups and is in use by over ten million people today. Instant messaging (IM) is an Internet protocol (IP)-based application that provides convenient communication between people using a variety of different device types. The most familiar today is computer-to-computer instant text messaging, but IM also can work with mobile devices, such as digital cellular phones, and can incorporate voice or video.

The millions of people using current Internet IM services and the growing popularity of short text messaging on mobile phones demonstrate that a market exists for IM services. Carriers can take advantage of this opportunity by offering advanced messaging services that integrate both fixed and mobile access and add new features that are not possible on free Web-based messaging services.

Because IM is a text-based service, instant messaging communication is generally not burdened by the need to transfer large graphic, sound, or program files. As a result, instant messaging is a relatively quick and easy to use system. However, while instant messaging is widely available, its value as a means to access and retrieve data from a remotely located automated system is steadily increasing. One example of the expansion of instant messaging is a system, which interactively responds to and services requests from remotely located users. Such requests can include queries for general or specific information, requests to access and control various “WEB-enabled” devices, requests to store information for later use, reminder and paging services, as well as additional request-based functionality, such as suitable for use in various e-commerce environments.

Instant messaging was once the domain of teenagers who had found the high-tech equivalent to passing notes in class. They used the Internet and on-line services to chat from their computers. But with 600 million messages sent a day with America Online's messaging service alone, not to mention the other IM services such as MSN Messenger, Yahoo! Messenger, and Lycos Instant Messenger, use of this service has clearly moved to the mainstream as adults find messaging an easy, convenient way to communicate with friends, family, and colleagues with more immediacy than e-mail and without the expense of long-distance phone calls. Instant messaging allows end users to select “buddies” and assign these buddies to “buddy groups,” automatically register a person when on-line, advertise the user's selected buddies to the user when the selected buddies register on-line, advertise the user's presence on-line to others who have selected the user as a buddy, and participate in instant messaging communication between two on-line users.

As mentioned, instant messaging has become a very popular form of communication. In addition, IM has become a basic tool that people use to conduct business. Many users create “buddy lists” using this instant messaging technology. These buddies service as point-to-point contacts for transmitting messages instead of entering a specific email address. However, as with email, it is common that the recipient of an instant message does not respond to the message in a timely manner. Several reasons may exist for this failure to respond. In any event, with this failure of response, the instant messaging system does not accomplish the designed objective.

Instant messaging provides an extremely useful tool to increase productivity. In fact many corporation rely heavily on IM as part of their business process. However, productivity is lost when people are not available to answer the transmitted instant messages. Regardless of whether the recipient is away from their desk, too busy or not logged into the system, failure to respond to these messages hampers productivity. There remains a need for a method and system by which the sender of an instance message can receive a timely response to the message, even in the case when the intended recipient of the message does not submit a timely response.

### SUMMARY OF THE INVENTION

It is an objective of the present invention to provide a method and system by which the sender of an instant message can receive a timely response to the message, even in the case when the intended recipient of the message does not submit a timely response.

It is a second objective of the present invention to provide a method that creates an alternate recipient of an instant message when the initial message recipient does not reply to the message.

It is a third objective of the present invention to provide a means to define a time period in which the recipient of an instant message has to respond to the message.

It is a fourth objective of the present invention to provide a list of alternate recipients to an instant message when the initial message recipient does not reply to the message.

It is a fifth objective of the present invention to provide a means to define the further ability for the list of alternate recipients to be configurable or definable by both the initiating sender AND a receiver. In a sense this, this allows a receiver to redirect incoming Instant Message session based on his own alternate recipient criteria. So, it is possible for two separate rules to be enforced simultaneously.

It is a sixth objective of the present invention to provide a means to define a method that allows specifications of these alternate recipient lists on the mail server itself, allowing for redirection to occur even if the user is not currently on-line.

The present invention is a method by which the sender of an instant message can designate an alternate recipient of the message in the event the initial recipient does not respond to the message within a predetermined time period. In the implementation of the present invention, the sender of the message designates as part of the message one or more alternates that can receive this message. The message creator also defines a time period within which the creator wants the recipient to respond to the message.

In the present invention, the creator sends the message to the primary destination. The sending of the message starts a timer. The timer can run until a response message is received at the sender location or until it reaches the predefined time period. If the sender receives a message from the recipient within the defined time period, the timer terminates. If the sender does not receive a reply message from the recipient within the defined time period, the method retrieves the alternate recipient and transmits that message to the alternate recipient. In one alternate approach, there can be more than one alternate recipient. In the case of multiple alternates, the message can be sent to each alternate simultaneously or there can be a priority among the alternates. With the priority approach, the first alternate will receive the message. If that alternate does not respond, the next alternate on the list receives the message, until there is a response to the message.

In an alternate embodiment, the process of the present invention can occur at the recipient location. The method at the recipient would determine whether there has been a timely response. When there is no timely response, the message would be forwarded to an alternate recipient. The alternate recipient list used here is one, which was predefined and preconfigured by the receiver.

Current technology is available to make this type of instant messaging redirection process possible and automatic. The target user can enter all of the information needed for an algorithm of the present invention to determine where to redirect the instant message. The instant message initiator can determine whether they would even desire to have their message redirected to an alternate recipient.

### BRIEF DESCRIPTION OF THE DRAWINGS

FIG. 1 depicts data processing equipment a system that can be utilized to implement the present invention.

FIG. 2 is a diagram of a computer network over which users can transmit and receive message in accordance with the method and system of the present invention.

FIG. 3 is an illustration of a typical network system in which an instant messaging buddy system can be implemented in accordance with the present invention.

FIG. 4 is a typical display of a buddy list used to contact persons in an instant messaging environment.

FIG. 5 is an illustration of an instant messaging list with one alternate recipient in accordance with the present invention.

FIG. 6 is an illustration of an instant messaging list with several alternate recipients arranged in a priority order in accordance with the present invention.

FIG. 7 is an illustration of an instant messaging list with several alternate recipients arranged such that multiple alternates receive the message simultaneously.

FIG. 8 is an illustration of the main steps in the implementation of the method of the present invention.

FIG. 9 is a flow diagram of the general steps in one embodiment of the method of the present invention.

FIG. 10 is a flow diagram of the steps in one embodiment of the method of the present invention using a submission of the message to multiple alternate recipients.

FIG. 11 is a flow diagram of the steps in one embodiment of the method of the present invention using a simultaneous submission of the message to multiple alternate recipients.

FIG. 12 is an illustration of the main steps in the implementation of the method of the present invention when the message recipient forwards the message to another location.

FIG. 13 is a flow diagram of the general steps in one embodiment of the method of the present invention when the message recipient implements the method of the present invention and forwards the message to another location.

FIG. 14 is a flow diagram of the implementation of the steps of the present invention at the message recipient location using a submission of the message to multiple alternate recipients.

FIG. 15 is a flow diagram of the steps in one embodiment of the method of the present invention at the recipient location using a simultaneous submission of the message to multiple alternate recipients.

### DETAILED DESCRIPTION OF THE INVENTION

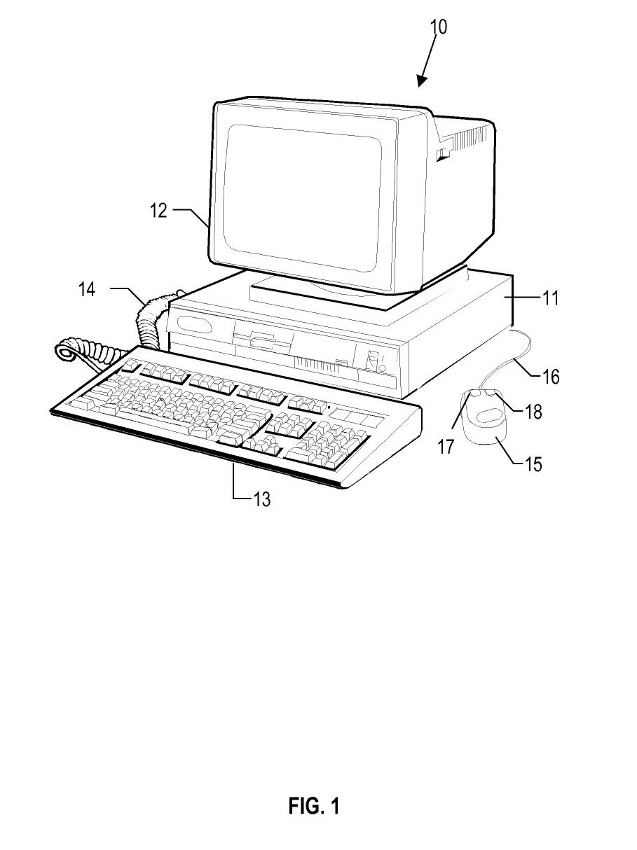

Electronic mail message transmissions occur over computing devices, usually personal computers, connected to a communication network. With reference now to FIG. 1, there is depicted a pictorial representation of computing device 10 which may be used in implementation of the present invention. Although the invention is described in terms of the device illustrated in FIG. 1, other types of electronic devices capable of transmitting and receiving information can be used in the implementation of the present invention. As seen in FIG. 1, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

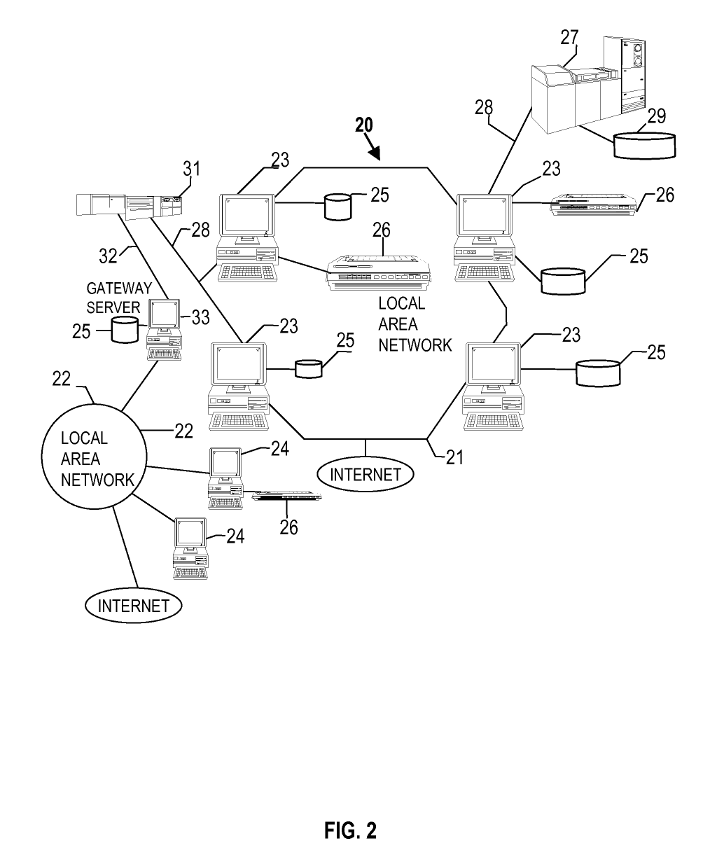

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

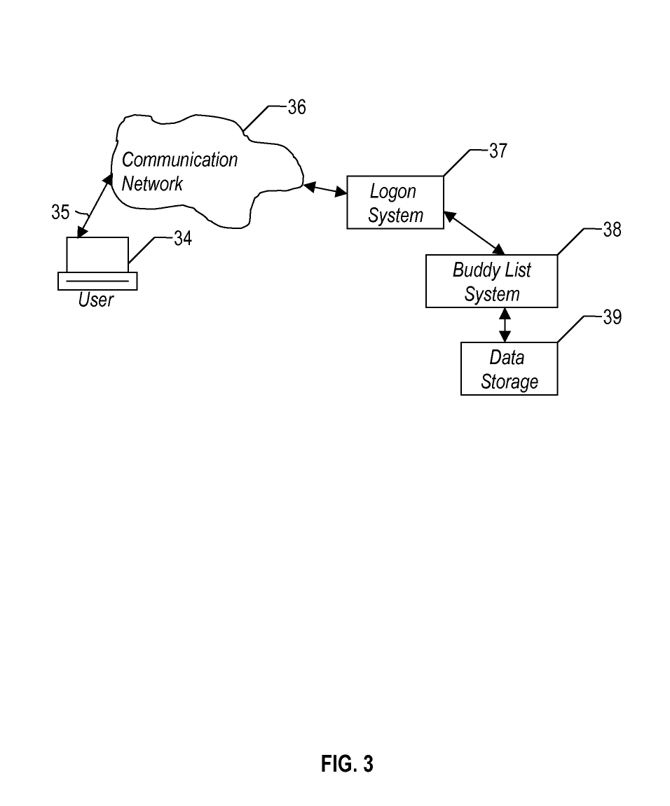

Referring to FIG. 3, shown in a diagram of a typical communication network 30 over which an instant messaging buddy system can be implemented in accordance with the present invention. The network system 30 includes a plurality of user stations 32 having a network link 33. The network link 33 is for receiving and transmitting data in analog or digital form over a communications network 34, such as the Internet. The communications network 34 connects each user station 32 as a “client” to a logon system 35, which is typically a software program executing on a remote server somewhere on a network. The logon system 35 communicates with a “Buddy List System” 37, which is preferably a software program executing on a server somewhere on the network. The Buddy List System 37 maintains a database 38 for storing user information. The database 38 may be of any type, such as relational or hierarchical, and may be centralized or distributed. For example, the database 38 may be stored at least in part on each user's own station 32. In such a case, the database 38 contents would be transmitted to the Buddy List System 37 when the user logged into the system.

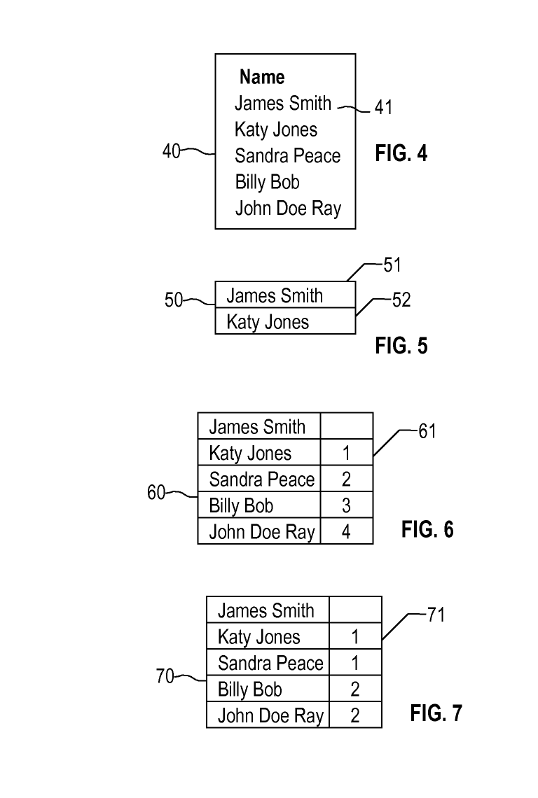

FIG. 4 is a typical display of a buddy list 40 used to contact persons in an instant messaging environment. This list can be one or more persons. As shown, this list comprises five individuals that could receive an instant message in the event the initial recipient does not respond in a predefined time period. The creator and sender of an instant message can create this list. In the alternative, the list could be members of a group, team or company department. The list can be any length. The primary recipient of the message can be an entry in the list or that contact can be separate. In FIG. 4, the first entry, James Smith 41, could be the primary message recipient. In that case, the alternate list would comprise the remaining four individuals.

FIG. 5 is an illustration of an instant messaging list with one alternate recipient in accordance with the present invention. This list 50 comprises the primary recipient, James Smith 51 and the alternate recipient Kathy Jones 52. The list can also have a field containing the address that is the destination of the message.

FIG. 6 is an illustration of an instant messaging list with several alternate recipients arranged in a priority order in accordance with the present invention. In this embodiment, the list 60 contains the primary recipient and the alternates. However, with this implementation, the alternate recipients are listed in a priority order. The first individual in ascending order has the higher priority. In FIG. 6, Kathy Jones is the highest or first alternate followed by Sandra Peace, Billy Bob and John Rae Doe. An alternative listing could have a field 61 for each entry that designates the priority of that entry in the order. The number in the field indicates the position in the order. With this approach, the actual position of an entry in list would not matter. The method would rely on the number in the field 61 to determine priority of the entries.

FIG. 7 is an illustration of an instant messaging list with several alternate recipients arranged such that multiple alternates receive the message simultaneously. In this approach, the sender can designate groups of alternates that can simultaneously receive the message. This list 70 would multiple alternate recipients that could receive the message. However, the recipients would be grouped and alternate in the group would have the same priority for receiving the message. A field 71 adjacent each entry would contain the priority number for that entry. In FIG. 7, Kathy Jones and Sandra Peace would have a priority for receiving a forwarded message. If neither Jones nor Peace responded to the initial message within the defined time period, the message would be forwarded to Billy Bob and John Doe Ray. Another alternate embodiment can be to simultaneously send the message to each entry on the list. With this approach, there would no need for priority fields.

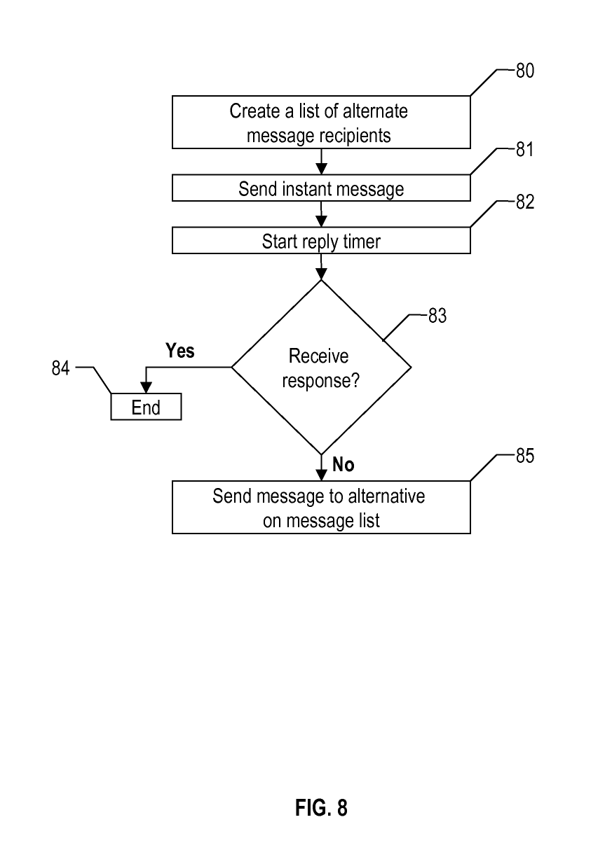

FIG. 8 is an illustration of the main steps in the implementation of the method of the present invention. The initial step 80 is to create a list of one or more alternate individuals to receive the message if the primary recipient does not respond in a timely manner. The message creator/sender can define a time within which the recipient should respond. Some instant messaging systems may implement a uniform response time. In this case, there is an automatic response time period. In step 81, the message is sent to the primary recipient. At the time the message is sent, step 82 starts the response timer. The timer is a counter that counts down from the defined time to zero. For example, if the response time was three minutes, the timer would count down from 180 seconds to zero seconds. The counting period could also be by minutes instead of seconds.

While the sender waits for a response, there is a monitoring process that occurs. This process determines in step 83 whether a response has occurred. If there has been a response to the message, the process terminates in step 84. If there was no response within the defined period, the step 85 retrieves the alternative and sends the message to this alternative. With regard to step 83, the monitoring can occur for the entire defined time period or if there is a response, the process can immediately move to the termination step 84.

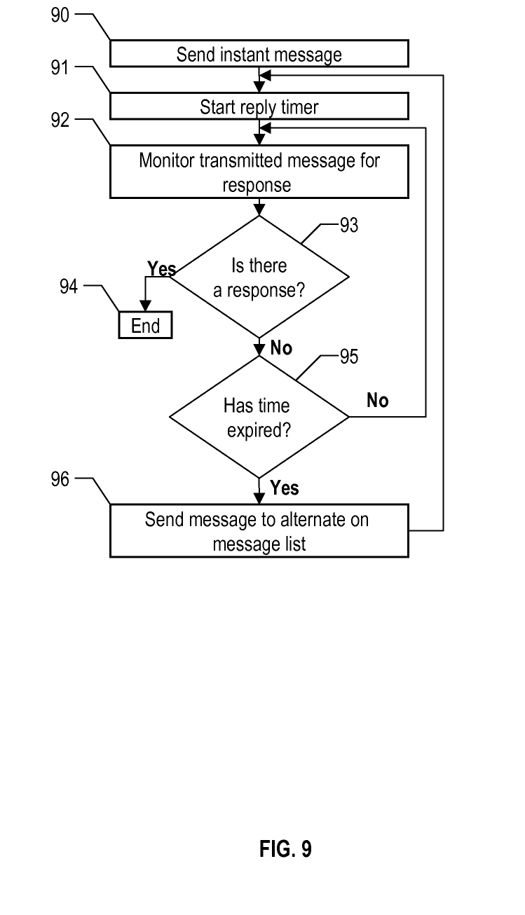

FIG. 9 is a detained flow diagram of the steps in one embodiment of the method of the present invention using a prioritized alternate recipient implementation. In this method, after the creation of the alternate list and defining the response time, step 90 sends the message to the primary recipient. Step 91 starts the timer. Step 92 monitors the sender location for a return message. Step 93 can send queries to the monitor to determine whether there has been a response to the message. In this process of FIG. 9, these queries would be at intervals shorter than the defined response time. For a three-minute response time, these queries may come every minute. If a response to the query is that the recipient has responded to the message, the process terminates at step 94. If there is no response, the process moves to step 95 that determines whether the response time has expired. If the response time has not expired, the process returns to the monitoring step 92. If the response time has expired, the process moves to step 96, which sends the message to the next alternate on the list.

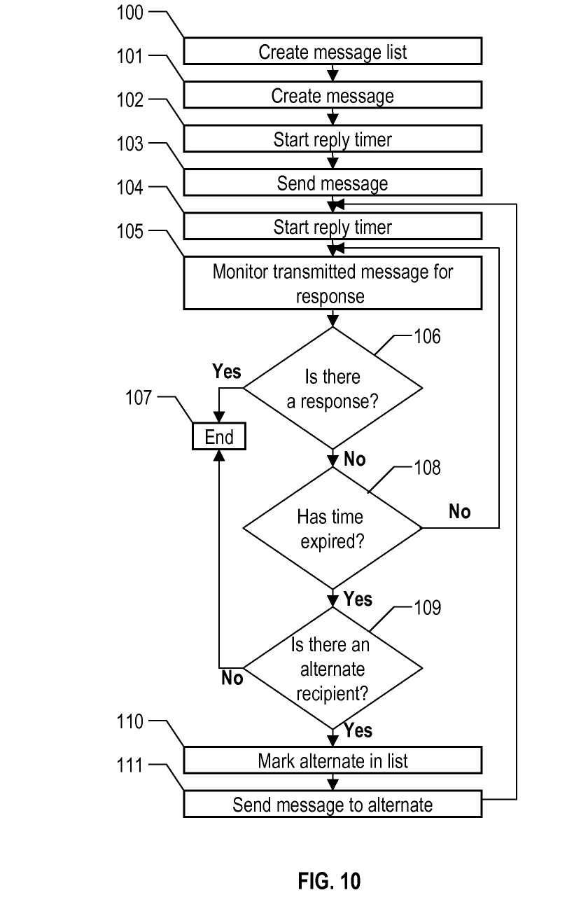

FIG. 10 is a flow diagram of the steps in one embodiment of the method of the present invention using a submission of the message to multiple message alternates. In steps 100 and 101 the user creates a message and a message list. The message list can be created as part of the message creation activity. The next step 102 is to define a response time as previously discussed. Step 103 sends the message to the primary recipient in the instant messaging process. Following the transmission of the message, step 104 starts a reply timer. At this point, the process enters a monitoring mode in step 105. In this monitoring mode, the process awaits a response to the message from the primary recipient. In step 106 and as part of the monitoring process, there is a determination whether the recipient has responded to the message. This optional determination step 106 occurs during the defined response time. The purpose for this step is to terminate the process in the event the recipient responds. When there is a response, there is no need to continue the process. If the recipient has responded to the message, the process ends in step 107. If the determination is that the recipient has not responded, the process makes a determination of whether the response time has expired in step 108. If the time has not expired, the process returns to the monitoring step 104. Referring to step 108, if the time has expired, the process moves to step 109 where there is a determination of whether there are alternate message recipients. If there are no alternate recipients, the process moves to step 106 and terminates. If there are alternate recipients, step 110 marks a recipient on the list and sends the message to that recipient in step 111. At this point, the process returns to 104. Referring to step 109, in the determination of alternate recipients, this step searches for the mark placed on an entry in step 110. This mark indicates that the message has been sent to the recipient.

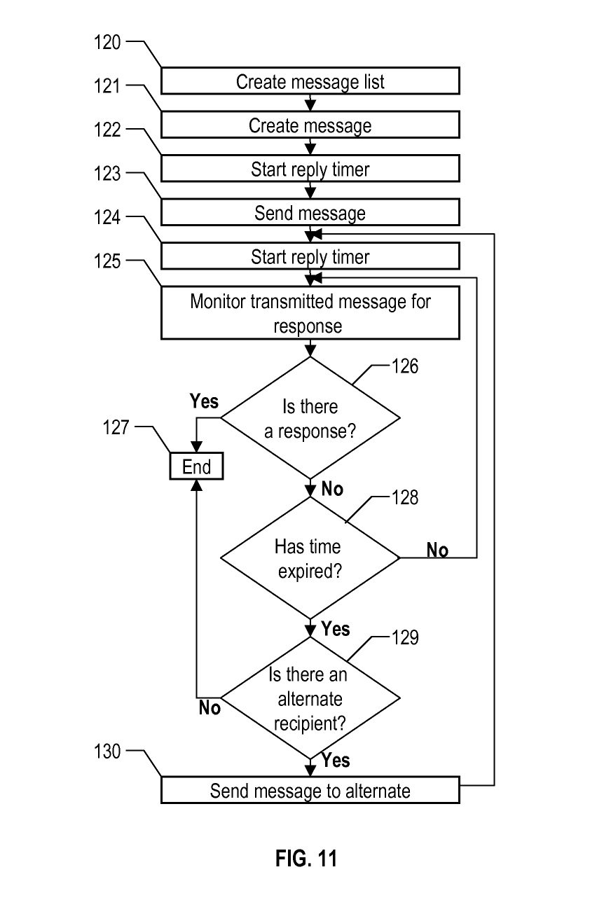

FIG. 11 is a flow diagram of the steps in one embodiment of the method of the present invention using a simultaneous submission of the message to multiple alternate recipients. This process is the same as with the process illustrated in FIG. 10 with the exception of the marking step 110. Steps 120, 121, 122, 123, 124, 125, 126, 127, 128 and 129 of the process of FIG. 11 are the same as the corresponding steps 100, 101, 102, 103, 104, 105, 106, 107, 108, 109, and 111 in FIG. 10 respectively. Referring to step 128, if the time has expired, the process moves to step 129 where there is a determination of whether there are alternate message recipients. If there are no alternate recipients, the process moves to step 127 and terminates. If there are alternate recipients, step 130 sends the message to each recipient in the message list created in step 120. At this point, the process returns to 104. Referring to step 109, in the determination of alternate recipients, this step searches for the mark placed on an entry in step 110. This mark indicates that the message has been sent to the recipient.

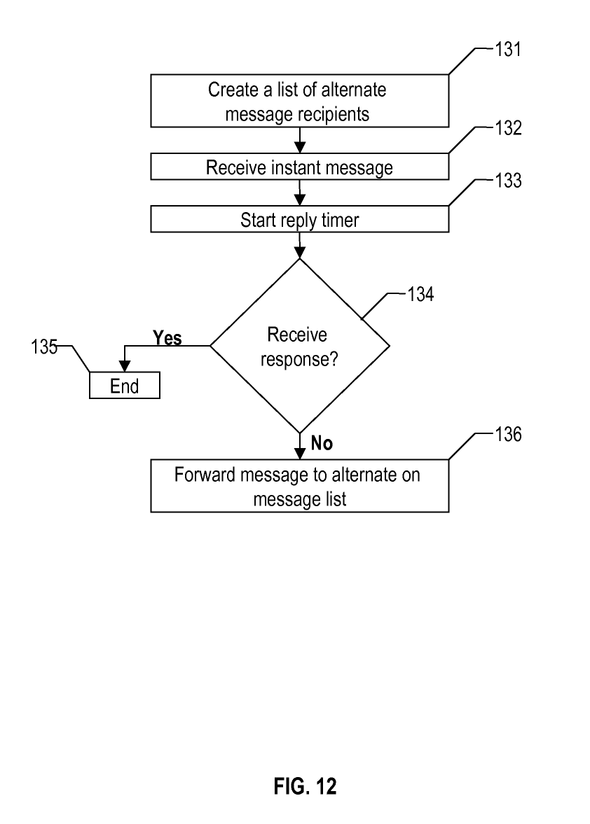

FIG. 12 is an illustration of the main steps in the implementation of the method of the present invention when the message recipient forwards the message to another location. This embodiment is similar to the flow diagram of FIG. 8 with the exception that the message recipient implements the method of the invention. In particular steps 131, 133, 134, 135 and 136 are the same as steps 80, 82, 83, 84 and 85 respectively. Step 132 varies step 81 of FIG. 8 in that this step is a receiving step instead of the transmitting step.

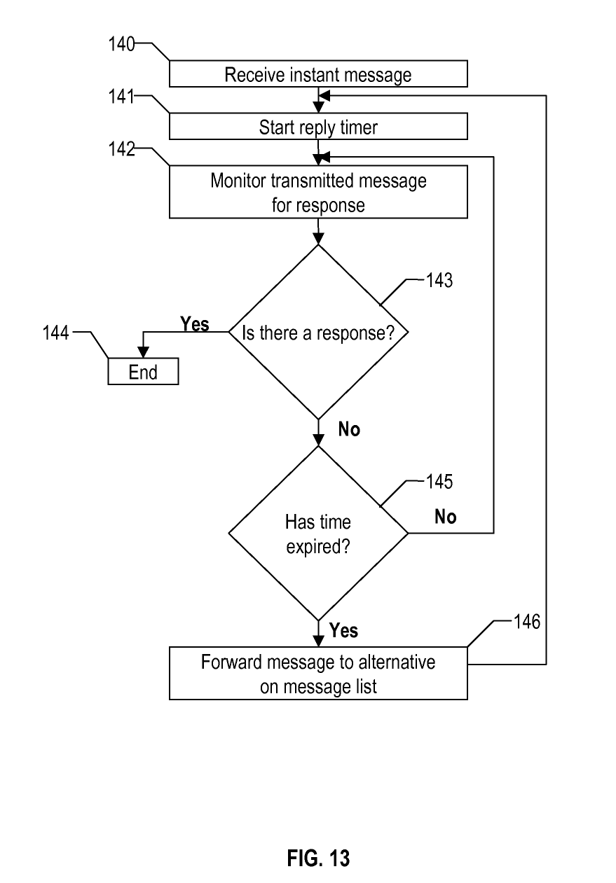

FIG. 13 is a flow diagram of the general steps in one embodiment of the method of the present invention when the message recipient implements the method of the present invention and forwards the message to another location. This embodiment is similar to the flow diagram of FIG. 9 with the exception that the message recipient implements the method of the invention. In particular steps 141, 142, 143, 144 and 145 are the same as steps 81, 82, 83, 84 and 85 respectively. Step 140 varies from FIG. 8 in that these steps function to receive the message at the recipient location. Step 146 forwards the message to an alternate recipient on the message list.

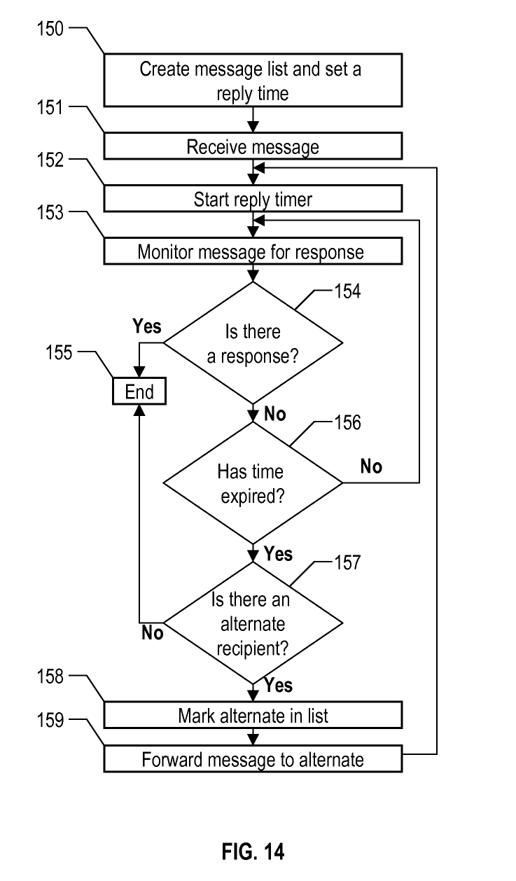

FIG. 14 is a flow diagram of the implementation of the steps of the present invention at the message recipient location using a submission of the message to multiple alternate recipients. This embodiment is similar to the flow diagram of FIG. 10 with the exception that the message recipient implements the method of the invention. In particular steps 152, 153, 154, 155, 156, 157, and 158 are the same as steps 104, 105, 106, 107, 108, 109 and 110 respectively. Step 150 creates the list of alternate recipients. Step 151 receives the message at the recipient location. Step 159 forwards the message to an alternate recipient on the message list.

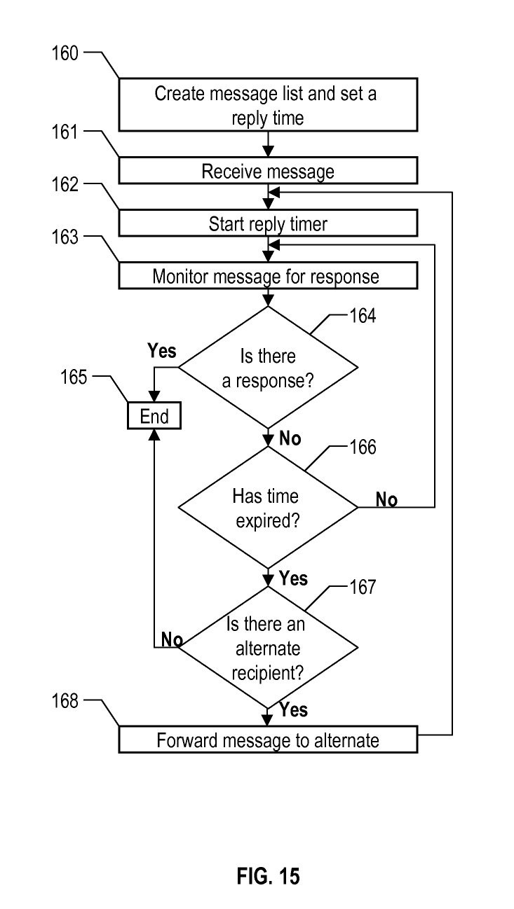

FIG. 15 is a flow diagram of the steps in one embodiment of the method of the present invention at the recipient location using a simultaneous submission of the message to multiple alternate recipients. This embodiment is similar to the flow diagram of FIG. 11 with the exception that the message recipient implements the method of the invention. In particular steps 162, 163, 164, 165, 166, and 167 are the same as steps 124, 125, 126, 127, 128, and 129 respectively. Step 160 creates the list of alternate recipients. Step 161 receives the message at the recipient location. Step 168 forwards the message to an alternate recipient on the message list.

Another embodiment of the present invention comprises a method and system in which both the sender and recipient generate alternate recipient lists. For example, the sender would implement the method described in FIG. 11 while the recipient would implement the method of FIG. 15. This dual approach can enhance the likelihood of a response to the message. It also provides for proper responses in the event a list assemble by the sender does not contain persons that are most appropriate to respond to the message.

This embodiment allows a receiver to redirect incoming Instant Message sessions based on his own alternate recipient criteria. So, it is possible for two separate rules to be enforced simultaneously.

The present invention could have other enhancements such as a filtering feature in which received messages can be sorted based on title or content. For example, USER A has a filer in place in the event a message is sent and has the character string ‘os400’ within the message. If USER A does not respond within the set time, the message will be forwarded to an alternate person who is an os400 expert.

In addition, a server can also hold policies so that the user does no need to be on-line for the message to be redirected. In this case, timeouts have not bearing since the recipient is not on-line. For example, if a particular expert person is not on-line and a user has a question regarding the component or product, the user needs to know to whom to direct the question. With this redirect policy, the message can be automatically forwarded to another person with knowledge of that subject.

The present invention enhances the current instant messaging features that are currently available to users. With this invention, a user has the ability to have their messages received and responded to in a more efficient manner. This invention is especially useful for groups or teams. When one member is not available to supply desired information, the requestor can contact another member of the team and receive the desired information.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A method for redirection of instant messages comprises:
creating a list of one or more message recipients;
establishing a response time for the recipient of a message to send a response to the sender of the message;
determining whether the recipient has sent a response within the established response time; and
redirecting the initial message to an alternate recipient on the created list when the determination is that the recipient has not responded to the initially sent message within the established response time.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The method as described in claim 1 further comprising before said response determining step, the steps of: starting a response timer; and monitoring the status of a response to the sent message at the sender.

22. The method as described in claim 21 wherein said response determining step further comprises the steps of: determining whether there is response from the initial recipient to the sent message; and determining whether the response time has expired, when there is a determination that there is no response from the initial recipient to the sent message.

23. The method as described in claim 22 wherein said response determining step further comprises the step of checking the status of a reply at the status monitor.

24. The method as described in claim 23 further comprising after said time expiration determination step, the step of determining whether there is an alternate recipient for the message.

25. The method as described in claim 24 wherein said message list creating step further comprises creating a list containing multiple alternate recipients.

26. The method as described in claim 24 wherein said message list creating step further comprises the step of prioritizing the recipients in the list in a desired order.

27. The method as described in claim 25 wherein said redirecting step further comprises redirecting the message simultaneously to each recipient in the list.

28. The method as described in claim 26 wherein said redirecting step further comprises redirecting the message to the recipients in the list in accordance with a prioritized order.

29. The method as described in claim 28 wherein the prioritized order could be by groups of recipients.

30. The method as described in claim 28 further comprising after said alternate determination step, the step of marking an alternate from the list.

31. The method as described in claim 30 wherein said alternate determining step further comprises the steps of: identifying an entry in the list; determining whether an entry in the list has a mark; and identifying that entry to receive the redirected message when the entry does not have a mark.

32. The method as described in claim 30 wherein said alternate determining step further comprises the steps of: identifying an entry in the list; determining whether an entry in the list has a mark; identifying the next entry in the list when the determination is that an entry is marked; repeating said determining whether an entry in the list has a mark; and terminating the process when each entry in the list has a mark.

33. The method as described in claim 1 wherein said creating, establishing, determining and redirecting steps are implemented at both sender and recipient.

34. The method as described in claim 1 wherein said creating, establishing, determining and redirecting steps are implemented when the recipient is not currently connected to the communication network at the time of the transmission of the instant message.

35. A computer program product in a computer readable medium for redirection of instant messages comprising:
instructions creating a list of one or more alternate recipients;
instructions establishing a response time for the recipient of a message to send a response to the sender of the message;
instructions determining whether the recipient has sent a response within the established response time; and
instructions redirecting the initial message to an alternate recipient on the created list when the determination is that the recipient has not responded to the initially sent message within the established response time.

36. The computer program product as described in claim 35 further comprising before said response determining instructions, instructions for: starting a response timer; and monitoring the status of a response to the sent message at the sender.

37. The computer program product as described in claim 36 wherein said response determining instructions further comprise: instructions for determining whether there is response from the initial recipient to the sent message; and instructions for determining whether the response time has expired, when there is a determination that there is no response from the initial recipient to the sent message.

38. The computer program product as described in claim 37 wherein said response determining instructions further comprise instructions for checking the status of a reply at the status monitor.

39. A system for redirection of instant messages, including processor and memory, comprising:
means for creating a list of one or more alternate recipients;
means for establishing a response time for the recipient of a message to send a response to the sender of the message;
means for determining whether the recipient has sent a response within the established response time; and
means for redirecting the initial message to an alternate recipient on the created list when the determination is that the recipient has not responded to the initially sent message within the established response time.
